(19) United States
(12) Patent Application Publication
(10) Pub. No.: US 2013/0036013 A1
(43) Pub. Date: Feb. 7, 2013

(54) METHODS AND APPARATUS FOR DYNAMICALLY PROVIDING ADVERTISEMENTS

(71) Applicants: Jason Thomas James, Chapel Hill, NC (US); Kenneth Lincoln Walls, Raleigh, NC (US); William Anthony Alford, Raleigh, NC (US); Lucas Gregory Rugani, Durham, NC (US); Michael Shawn Hagwood, Clayton, NC (US)

(72) Inventors: Jason Thomas James, Chapel Hill, NC (US); Kenneth Lincoln Walls, Raleigh, NC (US); William Anthony Alford, Raleigh, NC (US); Lucas Gregory Rugani, Durham, NC (US); Michael Shawn Hagwood, Clayton, NC (US)

(73) Assignee: ChannelAdvisor Corporation, Morrisville, NC (US)

(21) Appl. No.: 13/204,247

(22) Filed: Aug. 5, 2011

(51) Int. Cl. G06Q 30/02

(52) U.S. Cl. 705/14.66

(57) ABSTRACT

In some embodiments, a non-transitory processor-readable medium stores code representing instructions to cause a processor to receive a user defined advertisement rule associated with a set of products listed within an inventory database. The user defined advertisement rule has at least one dynamic field associated with a field within the inventory database including a product title field, a brand name field, a website address field, a description field, etc. The code also represents instructions to cause the processor to resolve the at least one dynamic field for each product using a datum stored within the field to define a different advertisement for each product. The code further represents instructions to cause the processor to provide the different advertisement for each product to a search engine such that each advertisement can be displayed by the search engine in response to one or more search requests at the search engine.

### BACKGROUND

Some embodiments described herein relate generally to systems that generate online advertisements, and, in particular, to methods and apparatus for dynamically providing advertisements for a search engine.

Some known advertisement-generation systems connect products with an online search marketing program such as an online search engine (e.g., Google, Bing). These systems can build search marketing campaigns (e.g., online advertisements) for products using highly focused and relevant keywords associated with the products. Such advertisement-generation systems, however, typically do not dynamically adjust or update campaign structures and elements such as promotional text, sale prices, etc., to reflect real-time ecommerce realities (e.g., changes in inventory levels, shipping methods, etc.).

Accordingly, a need exists for methods and apparatus that dynamically provide online advertisements for products in response to changes in aspects related to the products, thus improving the efficiency and performance of online search marketing campaigns.

### SUMMARY

In some embodiments, a non-transitory processor-readable medium stores code representing instructions to cause a processor to receive a user defined advertisement rule associated with a set of products listed within an inventory database. The user defined advertisement rule has at least one dynamic field associated with a field within the inventory database including a product title field, a brand name field, a website address field, a description field, etc. The code also represents instructions to cause the processor to resolve the at least one dynamic field for each product using a datum stored within the field to define a different advertisement for each product. The code further represents instructions to cause the processor to provide the different advertisement for each product to a search engine such that each advertisement can be displayed by the search engine in response to one or more search requests at the search engine.

### BRIEF DESCRIPTION OF THE DRAWINGS

FIG. 1 is a schematic illustration of a host device in communication with server devices via a network, according to an embodiment.

FIG. 2 is a block diagram illustrating a workflow of an inventory driven search service, according to an embodiment.

FIG. 3 is a block diagram illustrating a workflow of an advertisement group service, according to an embodiment.

FIG. 4 is a schematic illustration of a processor operatively coupled to an inventory database and configured to dynamically provide advertisements, according to an embodiment.

FIG. 5 is a flowchart illustrating a method for providing multiple advertisements for a product to a search engine, according to an embodiment.

### DETAILED DESCRIPTION

In some embodiments, a non-transitory processor-readable medium stores code representing instructions to cause a processor to receive a user defined advertisement rule associated with a set of products listed within an inventory database. The user defined advertisement rule has at least one dynamic field associated with a field within the inventory database including a product title field, a brand name field, a website address field, a description field, a past price field, a retail cost field or a shipping price field. The code represents instructions to cause the processor to resolve the at least one dynamic field for each product from the set of products using a datum stored within the field within the inventory database to define a different advertisement for each product from the set of products. In some embodiments, the code to cause the processor to resolve can include code to cause the processor to resolve the at least one dynamic field such that a value within the advertisement for a product from the set of products is converted from a format stored in the field within the inventory database to a common- display format. In some embodiments, the user defined advertisement rule can include another dynamic field associated with another field within the inventory database. In some embodiments, the code to cause the processor to resolve can include code to cause the processor to resolve the two dynamic fields with a calculation using datums stored within the two fields as inputs.

The code can also represent instructions to cause the processor to provide the different advertisement for each product from the set of products to one or more search engines such that each advertisement can be displayed by the search engine(s) in response to one or more search requests at the search engine(s). The code can further include code to cause the processor to receive an indication of a change in a value of the field of the inventory database. In some embodiments, the code can cause the processor to send, based on the indication, a request to the search engine(s) to suspend displaying the advertisement for a product from the set of products. Alternatively, the code can cause the processor to resolve, based on the indication, the at least one dynamic field for at least one product from the set of products to define an updated advertisement for the at least one product; and to provide the updated advertisement to the search engine(s) such that the updated advertisement can be displayed by the search engine(s) in response to the one or more search requests.

In some embodiments, the at least one dynamic field can be associated with a product title field. The code to cause the processor to resolve can include code to cause the processor to resolve the at least one dynamic field such that a product title within the advertisement for a product from the set of products has a first format if the product title in the first format has a number of characters less than a character limit, and the product title within the advertisement for the product has a second format if the product title in the first format has a number of characters greater than or equal to the character limit.

In some embodiments, the at least one dynamic field can be associated with a website address field. The code to cause the processor to resolve can include, for example, code to cause the processor to resolve the at least one dynamic field such that a website address associated with a product from the set of products is included in the advertisement for that product if the website address associated with the product has a number of characters less than a character limit. In some embodiments, a default website address can be included in the advertisement for the product if the website address associated with the product has a number of characters greater than or equal to the character limit.

In some embodiments, the at least one dynamic field can be associated with the shipping price field. The code to cause the processor to resolve can include, for example, code to cause the processor to resolve the at least one dynamic field such that the advertisement for a product from the set of products includes shipping information associated with that product.

In some embodiments, an apparatus can include a dynamic rule module, an advertisement definition module, and a communication module. The dynamic rule module can be configured to receive a user defined advertisement rule having at least one dynamic field, associate the user defined advertisement rule with a set of products stored within an inventory database, and associate the at least one dynamic field with a field within the inventory database. In some embodiments, each product from the set of products can have a value associated with the field within the inventory database. In some embodiments, the field within the inventory database can be one of a product title field, a brand name field, a quantity field, a website address field, a description field, a past price field, a retail cost field, or a shipping price field.

The advertisement definition module can be configured to resolve the at least one dynamic field for each product from the set of products using the value associated with the field for that product to define a different advertisement for each product from the set of products. The communication module can be configured to provide different advertisement for each product from the set of products to one or more search engines such that each advertisement can be displayed by the search engine(s) in response to one or more search requests at the search engine(s).

In some embodiments, the apparatus can further include an inventory monitor module configured to monitor the inventory database and provide an indication to the advertisement definition module if the value for a product from the set of products is modified. Based on the indication, the advertisement definition module can be configured to resolve the at least one dynamic field for that product using the value for that product. Alternatively, the advertisement definition module can be configured to send a suspension indicator to the communication muddle such that the communication module can send, based on the suspension indicator, a request to the search engine(s) to suspend displaying the advertisement for the product from the set of products.

In some embodiments, the user defined advertisement rule can include another dynamic field. In some embodiments, the dynamic rule module can be configured to associate the other dynamic field with another field within the inventory database, and each product from the set of products having a value associated with the other field within the inventory database. The advertisement definition module can be configured to resolve the two dynamic fields for each product from the set of products based on a calculation using values associated with the two fields of the inventory database as inputs.

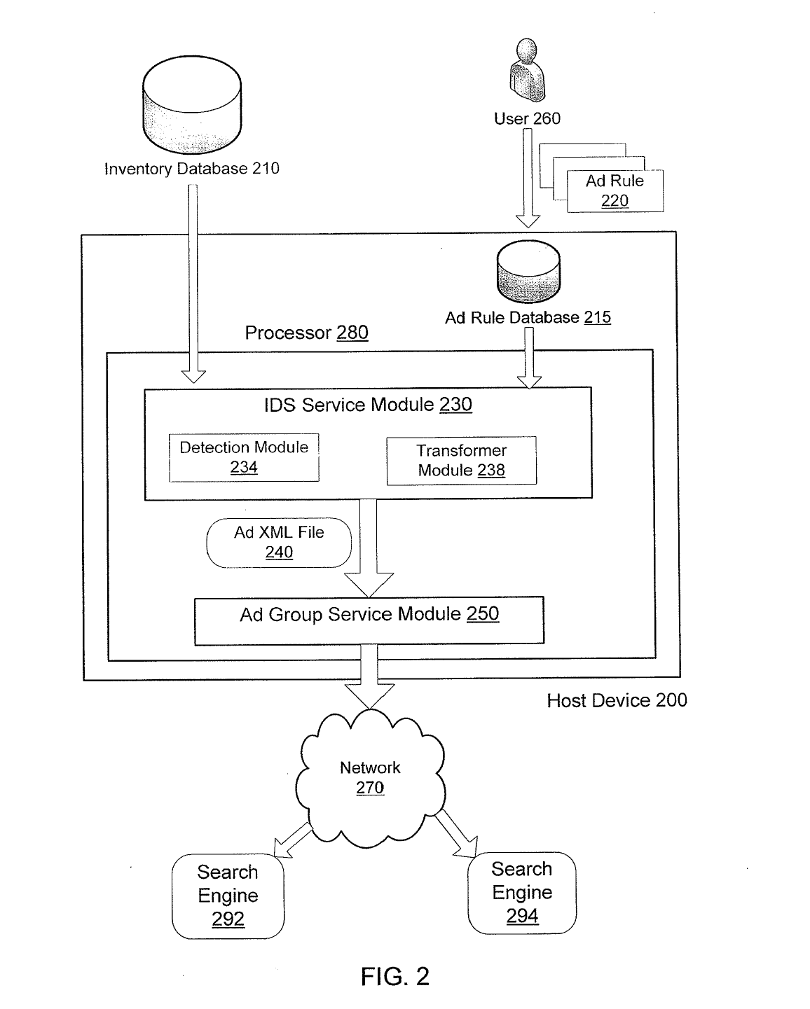

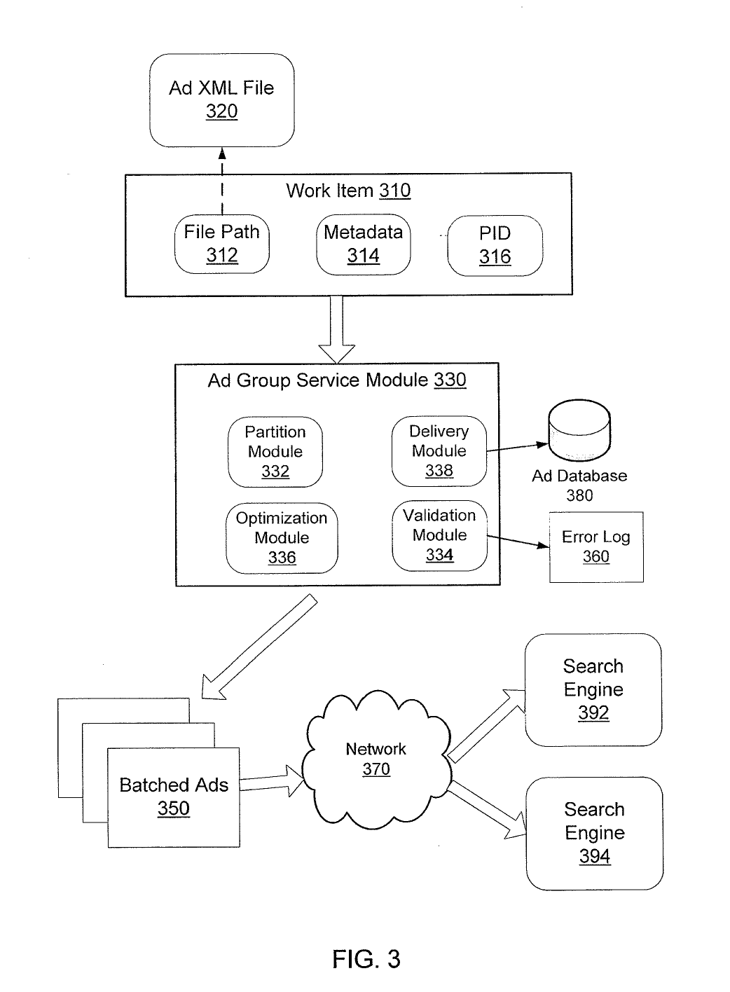

As used herein, a module can be, for example, an assembly of hardware or software modules (executing in hardware), or a set of operatively-coupled electrical components, and can include, for example, a memory, a processor, electrical traces, optical connectors, software (executing in hardware) and/or the like. For example, as described with respect to FIGS. 2-3, an inventory driven search (IDS) service module or an advertisement group service module can each be an assembly of hardware/software modules.

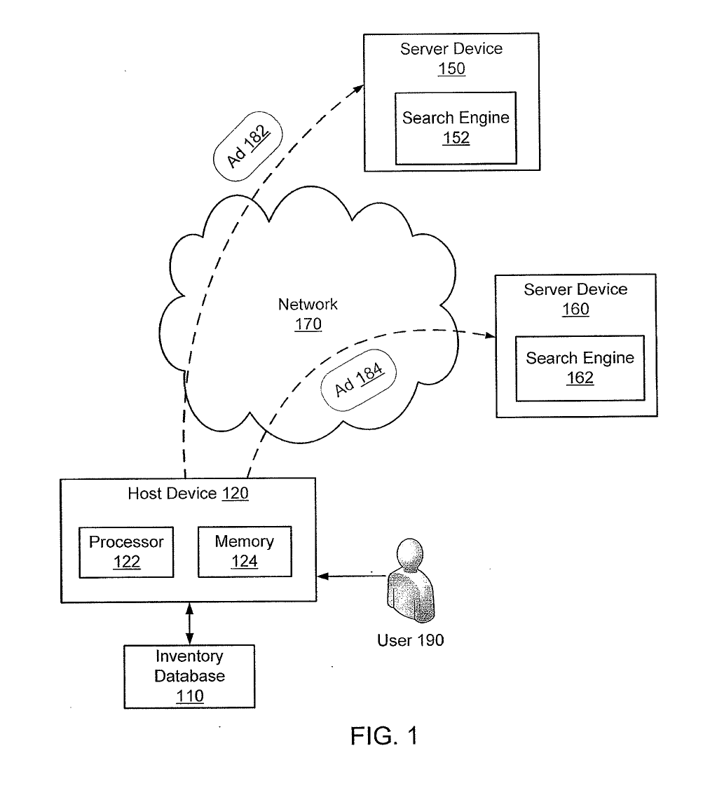

FIG. 1 is a schematic illustration of a host device 120 in communication with server devices 150 and 160 via a network 170, according to an embodiment. The network 170 can be any type of network (e.g., a local area network (LAN), a wide area network (WAN), a virtual network, a telecommunications network, the Internet, etc.) implemented as a wired network and/or wireless network. In some embodiments, for example, the server devices 150 and 160 can be computer servers connected to the host device 120 via an Internet service provider (ISP) and the Internet (e.g., network 170). Although only the server devices 150 and 160 are shown in FIG. 1, the host device 120 can be configured to be operatively coupled to and communicate with more than two server devices via the network 170.

As shown in FIG. 1, the host device 120 is operatively coupled to an inventory database 110 and can be accessed by a user 190. In some embodiments, the host device 120 can be directly connected to the inventory database 110. Alternatively, the host device 120 can be coupled to the inventory database 110 via, for example, a network (not shown in FIG. 1). In some embodiments, user 190 can directly access and operate on the host device 120. Alternatively, although not shown in FIG. 1, user 190 can remotely access the host device via a computing device (e.g., a personal computer) through a network (e.g., the Internet).

User 190 can be one or a group of persons that can access and operate the host device 120 to provide online advertisements of one or a set of products, which user 190 wishes to sell or market, via the server devices 150 and 160. For example, user 190 can be a retailer, a store manager, a sales person, a product owner, etc. Specifically, user 190 can define data associated with a set of products that user 190 wishes to sell or market, and then send the data to the host device 120. As a result, the data sent by user 190 can be received at the host device 120 and stored in the memory 124 within the host device 120. In some embodiments, the data associated with the products can be one or a group of advertisement rules, as further described with respect to FIGS. 2-5.

The inventory database 110 can be any type of database (e.g., a relational database) that stores inventory data of one or a set of products, such as product title, description, quantity, URL, sale price, etc. The data associated with a product stored in the inventory database 110 can be updated in response to a change to the inventory of that product, such as an increase in the quantity, a change in the description, a reduction in the sale price, etc. The inventory database 110 can be periodically updated according to a schedule, and/or manually updated by an operator in charge of managing the inventory database 110. Additionally, in some embodiments, the products listed in the inventory database 110 can include the set of products that user 190 wishes to sell or market. In such embodiments, the inventory data associated with those products can be retrieved from the inventory database 110 by the host device 120. As a result, both the advertisement rules associated with the products of interest and the inventory data of those products can be made available at the host device 120 (e.g., the advertisement rules can be provided from user 190 and the inventory data can be retrieved from the inventory database 110). Thus, advertisements for those products can be defined at the host device 120 based on the corresponding advertisement rules and inventory data, as described in detail with respect to FIGS. 2-5.

The host device 120 can be any type of device configured to define advertisements for products, and also send data (e.g., the defined advertisements) over the network 170 to one or more of the server devices (e.g., the server device 150, 160). In some embodiments, the host device 120 can be configured to function as, for example, a server device (e.g., a web server device), a computing device, a network management device, and/or so forth. Although not shown in FIG. 1, in some embodiments, the host device 120 can include one or more network interface devices (e.g., a network interface card) configured to connect the host device 120 to the network 170.

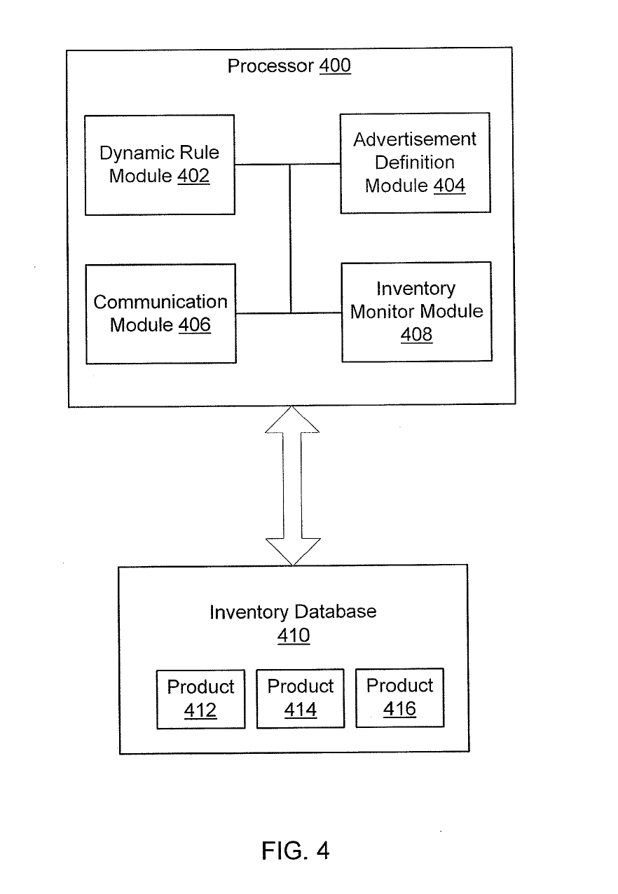

As shown in FIG. 1, the host device 120 includes a processor 122 and a memory 124. The processor 122 can be similar to the processor 280 and the processor 400 shown and described with respect to FIG. 2 and FIG. 4, respectively. Specifically, the processor 122 can include multiple hardware-based and/or software-based modules (stored and/or executing in hardware), each of which can perform one or more specific functions. Such functions can be associated with defining advertisements for products based on inventory data retrieved from the inventory database 110 and advertisement rules defined and provided by user 190, and/or delivering the defined advertisements to the server devices 150 and 160. Details of defining and delivering advertisements for products are described with respect to FIGS. 2-5.

The advertisements of products defined at the host device 120 can be used to promote or list the products for sale at, for example, online marketplaces (e.g., eBay, Amazon, etc.), comparison shopping websites (e.g., Nextag, Pricegrabber, etc.), online search engines (e.g., Google, Bing, etc.), user-hosted ecommerce storefront websites, social websites (e.g., Facebook, Groupon, Livingsocial, etc.) used for commerce, local deal websites, mobile commerce applications (e.g., executed on a smart phone), and/or the like. Additionally, a portion of the host device 120 (e.g., the processor 122) can be configured to automate or facilitate any type of further processing associated with the products (e.g., a transaction, a query, a comparison, an investigation, etc.).

The memory 124 can be, for example, a random access memory (RAM), a memory buffer, a hard drive, a database, and/or so forth. In some embodiments, the memory 124 of the host device 120 can act as a data repository. In such embodiments, the data associated with defining advertisements for a set of products (e.g., advertisement rules received from user 190, inventory data of the products retrieved from the inventory database 110, etc.) can be stored within the memory 124. When a user (e.g., a supervisor, a sales manager, etc.) wishes to view data associated with a specific product and/or a specific advertisement, the requested data can be retrieved from the corresponding location in the memory 124 and presented to the user via, for example, a display within or operatively coupled to the host device 120 (not shown in FIG. 1).

Further, in some embodiments, the memory 124 of the host device 120 can store account information associated with users authorized to access the data stored in the memory 124 and operate the host device 120. Each user can be authorized to access certain locations of the data stored in the memory 124, and/or operate the host device 120 to define advertisements for a certain set of products. For example, a sales manager can be authorized with a full access (e.g., view, add, modify, delete) to all the advertisement rules stored in the memory 124 for their company; while a sales associate can be authorized with only a partial access (e.g., view, add, but not modify or delete) to the advertisement rules stored in the memory 124 for their company. In such embodiments, the host device 120 can store, within the memory 124, a username and password associated with a user, extent of authority of the user (e.g., access rights), and/or the like. Alternatively, such information can be stored in a database (not shown in FIG. 1) within or operatively coupled to the host device 120.

The server device 150 or 160 can be, for example, a computer server, a computing entity, a host device, a monitoring device, and/or so forth. As shown in FIG. 1, the server device 150 includes a search engine 152 and the server device 160 includes a search engine 162. Similarly stated, the server device 150 can include a module that executes a search engine 152 and/or a search engine process and the server device 160 can include a module that executes a search engine 162 and/or a search engine process. As described in further detail with respect to FIGS. 2-5, the host device 120 can send one or more advertisements of one or more products (e.g., advertisements 182 and 184 shown in FIG. 1), which are defined at the host device 120, to the search engine 152 or search engine 162 of the server devices 150 and 160, respectively. Similarly stated, the host device 120 can send the advertisements to a server (e.g., server device 150, 160) and/or process (e.g., search engine 152, 162) configured to manage, execute and/or run a search engine process. The advertisements 182 and 184 sent from the host device 120 can be stored at the server devices 150 and 160. As a result, in response to the search engine 152 or 162 receiving a search request associated with the products (e.g., using certain keywords), the search engine 152 and 162 can be configured to display the advertisement 182 and/or 184, for example, on a display device (not shown in FIG. 1) within or operatively coupled (e.g., via a network such as the Internet) to the server device 150 and/or 160.

As discussed above, the server devices 150 and 160 can receive data (e.g., advertisements) from the host device 120 via network 170. The advertisements sent from the host device 120 to the server devices 150 and 160 can be formatted using any suitable format. In some embodiments, for example, the advertisements can be formatted using extensible markup language (XML), hypertext markup language (HTML) and/or the like.

In some embodiments, portions (e.g., the processor 122) of the host device 120 can include one or more hardware-based modules (e.g., a digital signal processor (DSP), a field programmable gate array (FPGA)) and/or one or more software-based modules (e.g., a module of computer code to be executed at a processor, a set of processor-readable instructions that can be executed at a processor) configured to execute various functions. Similarly stated, one or more of the various functions associated with the host device 120 (e.g., the functions associated with the processor 122) can be included in and executed by one or more such modules (see, e.g., FIGS. 2-4).

In some embodiments, multiple modules within the processor 122 can coordinate to provide a service associated with defining and/or delivering an advertisement for a product. For example, as described with respect to FIG.. 2, a set of modules (e.g., detection module 234 and transformer module 238 shown in FIG. 2) within a processor (e.g., the processor 122) can be configured to provide a service that automates defining and modifying search engine advertisements for products based on advertisement rules and inventory data associated with the products. In some embodiments, such a service can be referred to as an inventory driven search (IDS) service, and the set of modules providing the IDS service can be included in a high-level IDS service module (e.g., IDS service module 230 shown in FIG. 2). For another example, as described with respect to FIG. 3, a set of modules (e.g., partition module 332, validation module 334, optimization module 336 and delivery module 338 shown in FIG. 3) within a processor (e.g., the processor 122) can be configured to provide a service that prepares, validates, and delivers advertisements of products to one or more search engines. In some embodiments, such a service can be referred to as an advertisement group service, and the set of modules providing the advertisement group service can be included in a high-level advertisement group service module (e.g., advertisement group service module 330 shown in FIG. 3).

FIG. 2 is a block diagram illustrating a workflow of an IDS service, according to an embodiment. As shown in FIG. 2, a host device 200 including a processor 280 is operatively coupled to and can be in communication with an inventory database 210. Also, the host device 200 can be accessed by and receive data from a user 260 (e.g., via a computing device and a network). Similar to the host device 120 and the processor 122 shown and described with respect to FIG. 1, the processor 280 is hosted at the host device 200, and can include multiple hardware-based and/or software-based modules (stored and/or executing in hardware), such as IDS service module 230 and advertisement group service module 250, as shown in FIG. 2. As described herein, the hardware and/or software modules included in the processor 280, including IDS service module 230 and advertisement group service module 250, can be configured to execute a series of specific functions associated with defining and delivering advertisements for a set of products. Furthermore, the host device 200 can be operatively coupled to one or more search engines (e.g., the search engines 292, 294) via, for example, a network 270. As a result, the processor 280 within the host device 200 can be configured to send the advertisements of the products to the search engines 292 and 294 through the network 270.

Similar to the inventory database 110 in FIG. 1, the inventory database 210 can be any type of database that can be used to store inventory data of one or a set of products. In some embodiments, the inventory data of a product stored in the inventory database 210 can be updated in response to a change in the inventory of the product, such as a decrease in the quantity of the product that is available for sale, a change in the shipping method for the product, a new URL for the product, etc. In some other embodiments, changes on the inventory data of a product stored in the inventory database 210 can be triggered by a change (e.g., an action, an event) from an outside source. For example, a reduction of the sale price for the product can be triggered by a drop in the price of a competitor's product, or a release of a new version of the product. For another example, an increase of the shipping price for the product can be triggered by an increase of the price of a commodity such as, for example, gasoline. In such embodiments, a mechanism can be used to dynamically determine when and/or how to update the inventory data for a product based on the changes from an outside source.

The inventory data stored in the inventory database 210 can be updated in various methods. In some embodiments, the inventory data 210 can be automatically updated according to a periodic schedule, or triggered by a change in an outside source (e.g., an action from a competitor). In some other embodiments, the inventory data can be updated manually by, for example, a database operator, in response to an internal decision or an external command (e.g., triggered by a change in an outside source). Furthermore, the inventory data of a product stored in the inventory database 210 can be updated by any suitable means, such as manually entering data by the database operator, uploading files using a file transfer protocol (FTP) service, etc.

For each product listed in the inventory database 210, one or more fields can be stored in a data entry for that product within the inventory database 210. Each of the fields can be associated with an aspect of the product, such as, for example, a product title field, a headline field, a brand name field, an ad group name field, a picture field, a website address field, a display/destination URL field, a description field, a keyword field, a promotion field, a past price field, a current price field, a bid price field, a retail cost field, a shipping price field, a shipping method field, a warranty field, etc.

In some embodiments, a user (e.g., a manager of inventory database 210) can define custom fields. In such embodiments, such custom fields can be unique to a company, a product, an industry and/or the like. For example, a seller of media items (e.g., DVDs, Blu-ray discs, compact discs (CDs), books, etc.) might define a “release date” field in their inventory database. Using such a “release date” field, for example, advertisement rules can be defined to reduce the price of the media item, as displayed on an advertisement, after the media item has been released for a given time period. For another example, a provider of perishable goods might define an “expiration date” field in their inventory database. Using such an “expiration date” field, for example, advertisement rules can be defined to reduce the price of the perishable good as the expiration date approaches. In other embodiments, any other custom field can be defined by a user and used within a dynamic field of an advertisement rule.

For example, the inventory database 210 can be configured to store inventory data for a particular model of soccer cleats for sale at soccer.com. The inventory data for that model of soccer cleats can, for example, include the following fields: 1) a product title field having a value of “ADIDAS Telstar Limited Edition FG”; 2) a website address field having a value of “http://www.soccer.com/ProductPage.process?Section_Id=1&Product_ID=824”; 3) a quantity field having a value of “50”; 4) a retail price field having a value of “59.99”; and 5) a shipping price field having a value of “9.99”.

In some embodiments, the fields of a product listed in the inventory database 210 can be defined by a user (e.g., a sales manager, a product owner, etc.) associated with that product. For example, the fields of the inventory data for the soccer cleats listed above can be defined and entered into the inventory database 210 by a seller of the soccer cleats. Thus, different companies, products, brands and/or the like can include different fields in an inventory database. For example, an online store might include a field for shipping price while a physical retail store might include a street address. Furthermore, the fields of a product listed in the inventory database 210 can be recognized and used by IDS service module 230 and/or other modules of the processor 280, such that an advertisement for the product can be defined at IDS service module 230 based on the values of the corresponding inventory data fields.

To define an advertisement for a product listed in the inventory database 210, a portion of the inventory data (e.g., one or more values of the associated fields) for that product stored in the inventory database 210 can be retrieved from the inventory database 210 and sent to IDS service module 230 of the processor 280. Said in another way, IDS service module 230 can be configured to collect corresponding inventory data of a product of interest from the inventory database 210. In some embodiments, various mechanisms can be used to collect inventory data of a product from the inventory database 210. For example, the inventory data can be collected using a FTP service, manual file uploading through a user interface (UI) of the host device 200, data transmission via a web service application programming interface (API) associated with IDS service module 230, etc.

User 260 can be one or a group of persons that intend to promote, market, or sell one or more products listed in the inventory database 210. For example, user 260 can be a retailer, an owner, a sales person, etc., of the products of interest. Similar to user 190 in FIG. 1, user 260 can also access the host device 200, such that user 260 can operatively enable the modules of the processor 280 (e.g., IDS service module 230, advertisement group service module 250) to define and deliver advertisements for the products of interest.

For each product of interest, user 260 can define a set (one or more) of advertisement rules (e.g., advertisement rule 220 shown in FIG. 2) used to define an advertisement for that product. In addition to defining an advertisement, an advertisement rule can also be used to indicate that an advertisement is to be updated, suspended, etc. The advertisement rule 220 can be a transformative rule used to transmit metadata associated with the product (e.g., inventory data of the product) to an advertisement in a pre-defined form for that product. In some embodiments, the advertisement rule 220 can be in an executable form (e.g., a script, a macro) that can potentially reference the product's inventory fields stored in the inventory database 210. As a result, the advertisement rule 220 in such a form can be programmatically executed at, for example, IDS service module 230 to produce an advertisement for that product to be sent to a search engine (e.g., a search engine server and/or process). In some embodiments, an advertisement rule can be referred to as an advertisement template, a business rule, or an expression.

In some embodiments, the advertisement rule 220 can have one or more dynamic fields for a product, each of which is associated with a field in the inventory data for that product stored in the inventory database 210. In the example of the soccer cleats, the advertisement rule 220 can have a dynamic field “product title” associated with the product title field of the inventory data for the soccer cleats, and/or a dynamic field “shipping cost” associated with the shipping price field of the inventory data for the soccer cleats, etc. In some embodiments, the dynamic fields in an advertisement rule associated with a product can be defined by a user, such that each of the defined dynamic fields can be associated with a field in the inventory data for that product stored in the inventory database 210. Furthermore, as described in detail below, each dynamic field for a product included in the advertisement rule 220 can be resolved by using a value and/or datum stored within the associated field of the inventory data for that product.

After the advertisement rule 220 is defined by user 260, user 260 can transmit the advertisement rule 220 to the host device 200. In some embodiments, as shown in FIG. 2, the advertisement rule 220 can be sent to and stored at an advertisement rule database 215 within the host device 200. The advertisement rule database 215 can be hosted within a memory in the host device 200 (e.g., the memory 124 in the host device 120 in FIG. 1). When IDS service module 230 is configured to define an advertisement for a product based on an advertisement rule (e.g., advertisement rule 220) associated with the product, IDS service module 230 can be configured to retrieve the corresponding advertisement rule from the advertisement rule database 215. Additionally, in some embodiments, an advertisement rule can trigger IDS service module 230 to modify and/or suspend an advertisement for the product based on execution of an advertisement rule. In some other embodiments, the advertisement rule 220 provided by user 260 can be stored in a database remote from the host device 200 (not shown in FIG. 2) but operatively coupled to the host device 200 and accessible to IDS service module 230.

In some embodiments, the processor 280 can contain a feed processing system designed to receive inventory data of a product in any format, transform the inventory data into an advertisement for that product in a channel specific format (e.g., XML) using one or more user defined advertisement rules (e.g., advertisement rule 220), and deliver the transformed output (i.e., the advertisement) to external entities (e.g., search engines 292, 294).

As a portion of the feed processing system, IDS service module 230 of the processor 280 can be configured to retrieve data feed associated with a product of interest (e.g., inventory data of the product, advertisement rules for the product), process the incoming data feed, and automatically generate an advertisement for the product based on inventory data of the product in combination with the corresponding advertisement rules. Subsequent to IDS service module 230, as another portion of the feed processing system, advertisement group service module 250 of the processor 280 can be configured to validate the advertisement defined at IDS service module 230, format the advertisement according to requirements from one or more search engines, and then transmit the formatted advertisement to the corresponding search engines (e.g., search engine server and/or process).

As shown in FIG. 2, IDS service module 230 includes a detection module 234 and a transformer module 238. The detection module 234 can include application codes used to trigger actions on an advertisement for a product. The actions can be, for example, defining a new advertisement for the product; updating an existing advertisement for the product; withdrawing an advertisement for the product; etc. In some embodiments, such an action can be triggered or initiated by a user (e.g., user 260). For example, user 260 can send a signal to the detection module 234, which initiates a process to define a new advertisement for a product that is to be displayed at a search engine. In some other embodiments, such an action can be triggered by detection of a change in the data feed associated with the product, including the inventory data of the product stored at the inventory database 210 and/or the advertisement rules associated with the product stored at the advertisement rule database 215. In some embodiments, such an action is triggered by an advertisement rule that indicates when a new advertisement is to be defined and/or that indicates conditions under which an advertisement is to be modified.

In some embodiments, the detection module 234 can be configured to detect changes in one or multiple fields in the inventory data of a product listed in the inventory database 210, and trigger corresponding actions (e.g., based on an advertisement rule) on an advertisement for the product. For example, a change in a retail cost field of a product listed in the inventory database 210 can be detected by the detection module 234 based on an advertisement rule (e.g., used to indicate an advertisement should be updated), and then an advertisement for the product can be updated with a new price based on the advertisement rule. For another example, when a product is sold out and a quantity field of the product is cleared to 0, the change can be detected by the detection module 234 based on an advertisement rule (e.g., used to indicate an advertisement to be suspended when the quantity reaches 0), and then an advertisement for the product can be withdrawn from a search engine based on the advertisement rule, such that the advertisement can be suspended displaying at the search engine. In such embodiments, an indication of the change can be sent from the inventory database 210 to the detection module 234. In response to receiving such an indication, the detection module 234 can be aware of the change, and then subsequent actions can be triggered based on the advertisement rules associated with the advertisements for that product.

In some other embodiments, the detection module 234 can also be configured to detect a change in an advertisement rule associated with a product, and then trigger corresponding actions on an advertisement for the product. In some embodiments, changes in advertisement rules can be detected and flagged in the advertisement rule database 215. The detection module 234 can be configured to perform scheduled services on advertisement rules stored in the advertisement rule database 215 to detect any database flag and then trigger actions to modify associated advertisements appropriately.

After an action to define a new advertisement or update an existing advertisement for a product is triggered by the detection module 234, the transformer module 238 can be configured to define an advertisement for the product based on (updated) inventory data of the product and (updated) advertisement rules associated with the product. Specifically, the transformer module 238 of IDS service module 230 can be configured to transform incoming user product inventory data (e.g., from the inventory database 210) into an advertisement in a standardized common format (e.g., XML) using one or more user defined advertisement rules (e.g., advertisement rule 220). Particularly, in some embodiments, the transformer module 238 can include a transformation engine that can take input documents (e.g., inventory data of a product), apply transformative rules (e.g., advertisement rule 220) on the input documents, and produce outputs (e.g., advertisements in a standardized common format) based on the transformative rules.

As described herein, an advertisement rule (e.g., advertisement rule 220) can have one or more dynamic fields for a product, each of which is associated with a field in the inventory data for that product stored in the inventory database 210. In some embodiments, to define an advertisement for a product, the transformer module 238 can be configured to resolve each dynamic field in an advertisement rule (e.g., advertisement rule 220) using a datum stored within the associated field of the inventory data for the product. Said in another way, a dynamic field of an advertisement template defined by the advertisement rule can be dynamically populated by data pulled directly from a corresponding field (i.e., a field associated with the dynamic field) in the inventory database 210. Similarly, one or more dynamic fields can be used to resolve an advertisement rule used to determine when to update and/or suspend an advertisement.

In some embodiments, an advertisement rule can be used for a simple inventory field reference replacement. For example, an advertisement rule can be configured to populate an advertisement with a value contained in a “product title” field associated with a product within the inventory database. To define an advertisement for a product based on this advertisement rule, the transformer module 238 can be configured to resolve the product title in the advertisement rule using a value stored within the associated product title field of the inventory data for the product. As a result of applying such an advertisement rule on a model of soccer cleats that has a product title field “ADIDAS Telstar Limited Edition FG”, an advertisement with a product title “ADIDAS Telstar Limited Edition FG” can be defined.

In some embodiments, more complex advertisement rules can be applied, and more than one advertisement rule can be applied in sequence on a product to define an advertisement for the product. For example, an advertisement rule can be designed to standardize every brand name in a product title of an advertisement, such that only the initial letter of the brand name is capitalized. To update or define an advertisement for a product based on this advertisement rule, the transformer module 238 can be configured to resolve the product title in the advertisement rule using a value previously stored within the product title field of an existing advertisement, or using a value stored within the associated product title field of the inventory data for the product. As a result of applying such an advertisement rule on the advertisement resulted in the previous example, the product title for the soccer cleats in the advertisement can be changed from “ADIDAS Telstar Limited Edition FG” to “Adidas Telstar Limited Edition FG.” Thus, the product title is converted to a standardized common display format. In other embodiments, the text of any other value retrieved from the inventory database can be similarly modified by an advertisement rule.

Alternatively, the standardization process described in the previous example or any other operation for an advertisement can be performed using a lookup list. A lookup list can be, for example, a data structure in any suitable form (e.g., a table, an array, etc.) that includes one or more entries, each of which can be used to associate two or more items (e.g., text strings). In some embodiments, an entry included in such a lookup list can be used to replace a first item (e.g., a text string in an arbitrary format) with a second item (e.g. a text string in a standardized format) that is associated with the first item in the entry. For example, a lookup list named “search brand cleanup” can include multiple entries, each of which maps a brand name to a standardized display format. The entries included in such a lookup list can be, for example, (ADIDAS, Adidas), (/UMBRO CORP, Umbro), (nike, Nike), (/KELME, Kelme), etc. As a result of applying the lookup list “search brand cleanup” in the standardization process described in the previous example, the brand name used to resolve a product title dynamic field in the advertisement for the soccer cleats can be changed from “ADIDAS” to “Adidas.” In some embodiments, a lookup list can be used to resolve any number of formats to a common format. For example, ADIDAS, ADIDAS AG, and adidas ag can all be resolved, using the lookup list, to Adidas. In other embodiments, a lookup list can be used to resolve the values of any other field (e.g., model name, website, model number, etc.) to a common format.

For another example, an advertisement rule can be designed to limit the number of characters in a product title of a product within a character limit (e.g., 25). According to such an advertisement rule, in some embodiments, if a product title of a product stored within the associated inventory data for the product has a number of characters greater than or equal to the character limit, the product title can be changed to another format (e.g., a format modified based on the previous product title, or a format pre-defined by the advertisement rule) when the product title field is resolved to define an advertisement for that product. Otherwise, if the product title has a number of characters less than the character limit, the product title field can be resolved using the original product title stored in the inventory data to define the advertisement for that product. Similarly stated, in some embodiments, if a product title in an existing advertisement of a product has a number of characters greater than or equal to the character limit, the product title can be changed to a default format when the product title field is resolved to define a new (e.g. updated) advertisement for that product. In some embodiments, such a default format can be defined in the inventory database (e.g., within a field) and/or by the advertisement rule. In other embodiments, such a default format can be based on a previous product title (e.g., used in a previous advertisement), a brand name, a model number, and/or the like. If the product title has a number of characters less than the character limit, the product title field can be resolved using the original product title in the existing advertisement to define the new advertisement for that product.

In both scenarios, to define or update an advertisement for a product based on this advertisement rule, the transformer module 238 can be configured to resolve the product title in the advertisement rule using a value previously stored within the product title field of an existing advertisement, or using a value stored within the associated product title field of the inventory data for the product. As a result of applying this advertisement rule (with a character limit 25) on the advertisement resulted in the previous example, because the product title “Adidas Telstar Limited Edition FG” has more than 25 characters, the product title in the updated advertisement can be changed to another format, such as “Adidas Telstar FG.”

Similarly, for another example, an advertisement rule can be designed to limit the number of characters in a website address of a product within a character limit (e.g., 60). According to such an advertisement rule, if the website address has a number of characters greater than or equal to the character limit, the website address can be changed to a default website as an alternative; otherwise the website address is not changed. To define an advertisement for a product based on this advertisement rule, the transformer module 238 can be configured to resolve the website address in the advertisement rule using a value stored within the associated website address field of the inventory data base for the product. As a result of applying this advertisement rule (with a character limit of 60) on the soccer cleats described herein, because the website address “http://www.soccer.com/ProductPage.process?Section_Id=1&Product_ID=824” has more than 60 characters, the website address in the advertisement can be changed to a default website “http://www.soccer.com.”

In some embodiments, to define an advertisement for a product, the transformer module 238 can be configured to resolve each dynamic field in an advertisement rule (e.g., advertisement rule 220) using data stored within more than one field of the inventory data for the product. Said in another way, a dynamic field of an advertisement template defined by the advertisement rule can be dynamically determined by, for example, a calculation based on data retrieved from more than one field (e.g., a field associated with the dynamic field and another field) in the inventory database 210. Such a calculation can be conducted by the transformer module 238 according to the advertisement rule.

For example, an advertisement rule can be designed to promote a product by optionally providing a free shipping discount. According to such an advertisement rule, if the sum of the retail price and the shipping price of the product is more than $60 and the shipping price is less than $10, then the retail price shown in the advertisement can be changed to the retail price of the product plus $5, and the shipping price shown in the advertisement can be changed to “Free Shipping”; otherwise the retail price and the shipping price shown in the advertisement are the same as those in the inventory data of the product. To define an advertisement for a product based on this advertisement rule, the transformer module 238 can be configured to resolve the retail price and the shipping price in the advertisement rule with a calculation using a value stored within the associated retail price field, and a value stored within the associated shipping price field, of the inventory data for the product. As a result of applying this advertisement rule on the soccer cleats described herein, because the retail price in the inventory data is $59.99 and the shipping price in the inventory data is $9.99, the retail price shown in the advertisement is resolved to $64.99 (i.e., $59.99 plus $5), and the shipping price shown in the advertisement is resolved to “Free Shipping”, according to the advertisement rule.

For another example, an advertisement rule can be designed to promote a product that has a quantity value less than a threshold (e.g., close to sold out). According to such an advertisement rule, for example, if the retail price of the product is greater than $50 and the quantity of the product is less than 100, then the retail price shown in the advertisement can be changed to the retail price of the product plus $5, and the quantity shown in the advertisement can be changed to “Limited Availability”; otherwise the retail price shown in the advertisement is the same as that in the inventory data of the product, and the quantity is not shown in the advertisement. To define an advertisement for a product based on this advertisement rule, the transformer module 238 can be configured to resolve the retail price and the quantity in the advertisement rule with a calculation using a value stored within the associated retail price field, and a value stored within the associated quantity field, of the inventory data for the product. As a result of applying this advertisement rule on the soccer cleats described herein, because the retail price in the inventory data is $59.99 and the quantity in the inventory data is 50, the retail price shown in the advertisement is resolved to $64.99 (i.e., $59.99 plus $5), and the quantity shown in the advertisement is resolved to “Limited Availability”, according to the advertisement rule.

In addition to the calculations listed in the examples herein, other calculations and/or operations can be done, based on values retrieved from one or more fields in an inventory database, to dynamically determine a value for a dynamic field of an advertisement. The calculations and operations can include arithmetic operations (e.g., addition, subtraction, multiplication, division, etc.) and logical operations (e.g., and, or, xor, nor, nand, etc.) of values. In some embodiments, such a calculation and/or operations can be used to define contents of an advertisement (e.g., a price, a shipping price, etc.), or to determine whether to update, or suspend an advertisement for a product (e.g., based on a quantity, a rate of sell, etc.).

In some embodiments, to define an advertisement for a product, the transformer module 238 can be configured to resolve a dynamic field in an advertisement rule by performing one or more functions and/or operations on one or more text strings. Such string functions and/or operation can include, for example, string concatenation, string substitution, string comparison, searching/replacing text in a string, counting characters in a string, string formatting, string trimming, encoding a string to appear in a URL, etc. For example, an advertisement rule can be designed to find specific text within a string and replace matches with new text. For example, such an advertisement rule can replace the string “Telstar” with the string “Telstar II” and/or replace the string “FG” with the string “TRX TF”. Such an advertisement rule can be executed by the transformer module 238 to resolve the product title field of the advertisement for the soccer cleats described in the previous example. As a result, in such an example, the product title for the soccer cleats in the advertisement can be changed from “Adidas Telstar Limited Edition FG” to “Adidas Telstar II Limited Edition TRX TF.”

In some embodiments, the transformer module 238 can be configured to resolve a dynamic field in an advertisement rule based on one or more resources that dynamically change with, for example, a time, a locale, a condition, etc. For example, a dynamic field can be resolved by returning or using in a calculation, a current date, a locale associated with an Internet protocol (IP) address, a currency code for a locale, a currency conversion rate from one currency code to another, etc. For another example, a dynamic field can be resolved by presenting a keyword or picture retrieved from an online resource, a term translated into a foreign language, a website link provided from a search engine, etc.

As described herein, the transformer module 238 of IDS service module 230 can be configured to define various advertisements for different products based on different advertisement rules. In some embodiments, the transformer module 238 can be configured to define advertisements for different products based on a common advertisement rule. In such embodiments, because the data for each product retrieved from the inventory data in the inventory database 210 is typically different for each product, the resulting advertisements for the different products can be different. For example, the transformer module 238 can be configured to define an advertisement for a model of Nike soccer cleats based on those advertisement rules described in the previous examples. Because the Nike soccer cleats has a set of values for the inventory fields, which is different from that of the Adidas soccer cleats, the advertisement defined by the transformer module 238 for the Nike soccer cleats will be different from the advertisement defined for the Adidas soccer cleats. Similarly stated, in some embodiments, the transformer module 238 can be configured to define advertisements for multiple products based on a common advertisement rule.

In some embodiments, the transformer module 238 and/or other portions of IDS service module 230 can be configured to process data (e.g., inventory data of a product) using a set of pre-defined operations that are stored in a function library (not shown in FIG. 2) within the host device 200. The operations stored in the function library can be defined by a user (e.g., user 260) using an expression language, such as an Excel formula. Such operations can include, for example, an operation to evaluate the truth of a parameter, an operation to generate a text string, an operation to count a number of characters in a text string, an operation to reference an inventory field, etc. In some embodiments, instructions to execute the operations can be included in an advertisement rule that is used at the transformer module 238 to define an advertisement for a product. In other words, an advertisement rule can be constructed using one or multiple such operations to form a logical expression. When the advertisement rule is applied at the transformer module 238, each operation included in the advertisement rule is executed accordingly.

After an advertisement is defined at the transformer module 238, IDS service module 230 can be configured to send the advertisement to advertisement group service module 250. In some embodiments, IDS service module 230 can be configured to define advertisements for products such that the advertisement data is defined in a specific format (e.g., XML), and the advertisements are included in files of the specific format (e.g., advertisement XML file 240). Furthermore, in some embodiments, the advertisement files of the specific format can be batched into a group of files (e.g., advertisement group XML files). For example, an advertisement rule (e.g., advertisement rule 220) can be used to define how to produce batched advertisement data in a specific format (e.g., XML) from the inventory data of a product.

After the advertisement XML file 240 is received at advertisement group service module 250, advertisement group service module 250 can be configured to validate the advertisements included in the advertisement XML file 240, format the advertisements, and then transmit the formatted advertisements to the corresponding search engines (e.g., search engine 292, 294) via network 270 (e.g., the Internet). Details of operations at an advertisement group service module are described with respect to FIG. 3.

In some embodiments, the host device 200 can use external application programming interfaces (APIs, not shown in FIG. 2) to integrate with external search engines or other devices, such that advertisements can be sent from the host device 200 to servers or computers (e.g., server device 150, 160 in FIG. 1) that host the search engines. For example, the host device 200 can be configured to provide advertisements to search engines 292 and 294 (e.g., search engine for Google, Bing, etc.) via APIs associated with the search engine 292 and 294.

After an advertisement for a product is received at the search engine 292 or the search engine 294 from the host device 200, actions can be taken at the corresponding search engine. Specifically, if the received advertisement is a new advertisement for the product, the received advertisement can be stored at the corresponding search engine. Furthermore, the received advertisement can be displayed by the search engine 292 or the search engine 294 at, for example, a display device (not shown in FIG. 2) operatively coupled to the corresponding search engine (e.g., via a network such as the Internet), in response to one or more search requests made to the search engines. If the received advertisement is updated from an existing advertisement for the product previously sent to the search engine 292 or the search engine 294, the received advertisement can be stored at the corresponding search engine as a replacement of the old advertisement. Furthermore, the updated advertisement can be displayed by the search engine 292 or the search engine 294 in response to one or more search requests made to the search engines.

For example, after an updated advertisement for the soccer cleats described herein is received at the search engine 292, the updated advertisement can be stored at the search engine 292 as a replacement of an old advertisement for the soccer cleats that was previously stored at the search engine 292. For example, a user initiates a search request associated with the soccer cleats (e.g., using keywords associated with the soccer cleats) to the search engine 292 using a personal computer operatively coupled to the search engine 292. As a result, the updated advertisement for the soccer cleats can be sent from the search engine 292 to the personal computer of the user and displayed on the personal computer to the user with other associated search results.

In some embodiments, IDS service module 230 can be configured to generate a request to suspend displaying an advertisement for a product based on an indication associated with the product that is received at IDS service module 230. Such an indication can be sent from the inventory database 210 to IDS service module 230 as a result of a change in the inventory data for the product. For example, when the product is sold out and a quantity field of the product stored in the inventory database 210 has a value of 0, an indication indicating the out-of-stock status of the product can be sent from the inventory database 210 to IDS service module 230. More specifically, an advertisement rule can be defined to monitor the quantity field of the product. As a result, in some embodiments, IDS service module 230 can be configured to generate a request to suspend displaying an advertisement for the product based on an advertisement rule (e.g., used to indicate an advertisement to be suspended). Subsequently, the request can be sent from IDS service module 230, via advertisement service module 250, to search engines (e.g., search engine 292, 294) where the advertisement for the product is stored. In such embodiments, the search engines can be configured to suspend displaying the advertisement for the product in response to receiving the request.

FIG. 3 is a block diagram illustrating a workflow for an advertisement group service, according to an embodiment. Similar to advertisement group service module 250 in FIG. 2, advertisement group service module 330 is primarily responsible for coordinating the validation of advertisements received at advertisement group service module 330 (e.g., from an IDS service module) and the transmission of the advertisements to search engines (e.g., search engine 392, 394). As shown in FIG. 3, advertisement group service module 330 includes a partition module 332, a validation module 334, an optimization module 336, and a delivery module 338. Similar to the detection module 234 and the transformer module 238 in FIG. 2, each of the modules contained in advertisement group service module 330 can be a combination of hardware and/or software modules (stored and/or executing in hardware). Furthermore, each of those modules can be configured to execute one or more functions associated with validating, formatting, or delivering advertisements, as described in detail below.

Advertisement group service module 330 can be configured to receive a work item 310 from, for example, an IDS service module (e.g., IDS service module 230 in FIG. 2). Although not shown in FIG. 3, in some embodiments, the IDS service module can be configured to produce multiple work items to be processed by advertisement group service module 330. In such embodiments, the IDS service module can send the multiple work items to advertisement group service module 330 regularly and/or periodically according to a schedule. Each work item (e.g., work item 310) of the multiple work items can be associated with one or more advertisements defined at the IDS service module. In some embodiments, the multiple work items produced at the IDS service module can be stored in a queue (not shown in FIG. 3) for subsequent processing at advertisement group service module 330. The work items can be stored in the queue in a certain order such as, for example, a time of production of a work item, a priority level of a work item, etc. Advertisement group service module 330 can be configured to accept work items from the queue for further processing.

As shown in FIG. 3, work item 310 contains several data items describing the work (e.g., an advertisement) to be processed by advertisement group service module 330, including a file path 312, a metadata field 314, and a profile ID (PID) 316. The file path 312 points to and/or references one or more advertisement files (e.g., advertisement XML file 320) storing advertisement data defined at the IDS service module. As described herein, the advertisement data defined at an IDS service module can be defined in a specific format (e.g., XML), and the resulted advertisements can be included in files of the specific format (e.g., advertisement XML file 240 in FIG. 2, advertisement XML file 320 in FIG. 3). Thus, the advertisement data stored in the advertisement XML file 320 can be located by advertisement group service module 330 using the file path 312 included in the work item 310.

In some embodiments, multiple advertisement XML files that are used to store related advertisements can be grouped and/or classified into a certain campaign category, such that they can be potentially processed in batches at advertisement group service module 330. For example, a shoe retailer can have a campaign category “Boots” that includes advertisements for various types of boots, and another campaign category “Sandals” that includes advertisements for various types of sandals.

The metadata field 314 can be used to store other miscellaneous metadata or related information not included in the advertisement XML files (e.g., advertisement XML file 320) referenced by the file path 312. For example, the metadata field 314 can store a request, generated at the IDS service module, to suspend displaying an advertisement at a search engine. For another example, the metadata field 314 can store information on the search engines to which an advertisement is intended to be sent.

The PID 316 can be a unique identifier for a user account associated with a user authorized to access and operate the IDS service module and/or advertisement group service module 330. The PID 316 can be used to associate the work item 310 with the user that operates and/or oversees the process of defining and delivering the advertisement included in the work item 310. As described with respect to FIG. 1, account information associated with users authorized to access and operate modules (e.g., an IDS service module, an advertisement group service module, etc.) at a host device (e.g., the host device 120 in FIG. 1) to define an advertisement for a product can be stored in a memory (e.g., the memory 124 in FIG. 1) within the host device. Thus, after the work item 310 is received at advertisement group service module 330, the PID 316 can be verified using the user account information stored in a memory accessible to advertisement group service module 330, such that the validality of the user can be verified, and the extent of authority of the user can be confirmed.

After the work item 310 is received at advertisement group service module 330, a series of functions can be executed by the modules (e.g., partition module 332, validation module 334, optimization module 336, delivery module 338) in advertisement group service module 330. First, the partition module 332 can be configured to dereference the advertisement data carried by the work item 310. As a result, the advertisement data stored in the advertisement XML file 320 referenced by the file path 312 can be retrieved and made available at advertisement group service module 330. Subsequently, the partition module 332 can be configured to partition the retrieved advertisement data into smaller blocks of data for further processing. In some embodiments, the smaller blocks of data are produced such that advertisement data can be spread out into and iterated in subsequent modules, and processed in, for example, a pipeline formation. In some other embodiments, the smaller blocks of data can be produced to conform to advertisement size limitations set by search engines.

Second, the validation module 334 can be configured to scan the advertisement data for validation errors to ensure that the advertisement data has been formatted correctly. For example, if an advertisement title exceeds an allowed character limit of a search engine, the validation module 334 can be configured to detect an error. As a result, the advertisement is not sent to the search engine, and the error is logged by the validation module 334 at, for example, an error log 360. Additionally, the validation errors and/or status logged by the validation module 334 at the error log 360 can be used for potential user review.

Third, the optimization module 336 can be configured to check the advertisement data for duplicate data, such that redundant data is not transmitted and extra bandwidth costs can be saved. In some embodiments, the optimization module 336 can be configured to check the advertisement data against, for example, a pre-loaded hash code to detect whether the data already exists as-is on a live advertisement implemented at a search engine. As a result, if the advertisement data is already live, for example, it will not be sent to the search engine. At the end of this stage, each potential piece of advertisement data can be placed at the optimization module 336 into one of three states for further processing: ignore (e.g., when the data is live and unchanged at a search engine), produce (e.g., when the data is new to, or live but changed at, the search engine), or delete (e.g., when deletion of a live advertisement at a search engine is indicated).

Fourth, after an advertisement is validated by the validation module 334 and checked by the optimization module 336, the delivery module 338 can be configured to send the advertisement to a search engine via, for example, a network (e.g., network 370). As shown in FIG. 3, the delivery module 338 can be configured to generate and send batched advertisements (e.g., batched advertisements 350) to a search engine 392 or 394. In some embodiments, the batched advertisements 350 can be sent by the delivery module 338 using any suitable transmit protocol (e.g., HTTP) to search engine 392 and/or 394. In some embodiments, any error generated in the transmission or at the receiving search engine can be logged (e.g., in the error log 360) for further user review. Furthermore, if the transmission is successful, the delivery module 338 can be configured to store a copy of the advertisements in an advertisement database 380. In some embodiments, such an advertisement database can be stored in a memory within a host device that hosts advertisement group service module 330. In other embodiments, such an advertisement database can be separate and operatively coupled to the host device.

FIG. 4 is a schematic illustration of a processor 400 operatively coupled to an inventory database 410 and configured to dynamically provide advertisements, according to an embodiment. As shown in FIG. 4, the processor 400 includes a dynamic rule module 402, an advertisement definition module 404, a communication module 406, and an inventory monitor module 408. Each of the modules can be a hardware-based module (e.g., a DSP, a FPGA), a software-based module (e.g., a module of computer code to be executed at the processor 400, a set of processor-readable instructions that can be executed at the processor 400), or a combination of hardware and software modules. Each module hosted at the processor 400 can be operatively coupled to the other modules hosted at the processor 400. The processor 400 can be hosted at a host device, which can be similar to the host device 120 that includes the processor 122 as shown in FIG. 1.

Although shown with a different internal structure from the processor 280 in FIG. 2, the processor 400 can have a similar functionality to that of the processor 280. Specifically, the modules included in the processor 400 can be configured to dynamically define and provide advertisements in a similar manner as described with respect to FIGS. 2-3 for the modules (e.g., IDS service module 230, advertisement group service module 250, 330) included in the processor 280. Particularly, some of the modules included in the processor 400 and some of the modules included in the processor 280 can have similar components with similar functions, as described below.

Similar to the inventory database 110 and the inventory database 210 in FIGS. 1-2, the inventory database 410 can be any type of database that stores inventory data of a set of products including products 412, 414, and 416. The inventory data stored for the products 412, 414 and 416 in the inventory database 410 can include, for example, product title, description, promotion, quantity, product URL, sale price, retail cost, shipping price, shipping method, etc. For example, the product 412 can be a model of football jersey, and the inventory data for the football jersey stored in the inventory database 410 includes a product title, a quantity, a URL, a retail price, and a shipping cost. Furthermore, the inventory database 410 can be operatively coupled to the processor 400, such that the inventory data stored in the inventory database 410 can be retrieved and made available at the processor 400.

The dynamic rule module 402 can be configured to receive and store an advertisement rule defined by and received from a user. The advertisement rule can include one or more dynamic fields, each of which is associated with a field within the inventory data for a product 412, 414 or 416 stored within the inventory database 410. Furthermore, each product 412, 414 or 416 can have a value associated with the field stored in the inventory database 410. The dynamic field or the field within the inventory database 410 can be, for example, a product title field, a brand name field, a quantity field, a website address field, a description field, a past price field, a current price field, a retail cost field, a shipping method field, a shipping price field, etc. For example, an advertisement rule defined for jerseys can include dynamic fields “title”, “quantity”, “website address”, “sale price” and “shipping price”, which are, respectively, associated with the fields in the inventory data of the product 412 (i.e., the model of football jersey) including “product title”, “quantity”, “URL”, “retail price”, and “shipping cost”.

In some embodiments, the dynamic rule module 402 can include and/or be operatively coupled to a database used to store the received advertisement rules, such as the advertisement rule database 215 in FIG. 2. The dynamic rule module 402 can be configured to associate each dynamic field of an advertisement rule with the corresponding field within the inventory database 410. In some embodiments, the dynamic rule module 402 can be configured to associate the advertisement rule with a set of products (e.g., products 412, 414, 416) stored within the inventory database 410. For example, the dynamic rule module 402 can be configured to associate the advertisement rule defined for jerseys with the product 402, which is a model of football jersey. Furthermore, the dynamic rule module 402 can be configured to associate each dynamic field of that advertisement rule with the corresponding field for the product 402 within the inventory database 410.

Similar to the transformer module 238 in FIG. 2, the advertisement definition module 404 can be configured to resolve each dynamic field in an advertisement rule for a product using a value associated with a corresponding field for that product stored in the inventory database 410. Furthermore, based on different values associated with the corresponding field within the inventory database 410 for different products, the advertisement definition module 404 can be configured to define a different advertisement for each product.

For example, the advertisement rule for jerseys can be designed to fill the dynamic field “title” of an advertisement with a value contained in the “product title” field of the inventory data for a product. To define an advertisement for the product 412 based on this advertisement rule, the advertisement definition module 404 can be configured to resolve the title in the advertisement using a value stored within the associated product title field of the inventory data for product 412 (e.g., “Football Jersey”). As a result, an advertisement with a title “Football Jersey” can be defined for the product 412 at the advertisement definition module 404. Furthermore, if the same advertisement rule for jerseys is also applied on the product 414, which has a product title “Basketball Jersey”, then another advertisement with a title “Basketball Jersey” can be defined for the product 414, which is different from that defined for the product 412.

In some embodiments, similar to the transformer module 238 in FIG. 2, the advertisement definition module 404 can be configured to resolve each dynamic field in an advertisement rule for a product using values associated with multiple fields for that product stored in the inventory database 410. In other words, a dynamic field of an advertisement defined by the advertisement rule can be dynamically determined by, for example, an operation (e.g., a calculation, a mathematical operation, a logical operation, etc.) based on values retrieved from the multiple fields in the inventory database 410. Such a calculation can be conducted by the advertisement definition module 404 according to the advertisement rule.

For example, the advertisement rule for jerseys can be designed to set the dynamic field “price” in an advertisement based on values of the fields “retail price,” “shipping cost,” “additional costs,” and “profit” of the inventory data. Specifically, the price of an item can be calculated using the values of the fields “retail price,” “shipping cost,” “additional costs,” and “profit” of the inventory data. For example, a price displayed on the advertisement can be calculated by adding the values of the fields “retail price,” “shipping cost,” “additional costs,” and “profit” of the inventory data. For another example, the field “profit” can be a percentage and the price displayed on the advertisement can be calculated by adding the values of the fields “retail price,” “shipping cost,” and “additional costs” and multiplying the result by the value of the field “profit” plus one. Accordingly, using such rules, the price of an item can be dynamically altered based on costs and/or changes in a desired profit. In other embodiments, any other dynamic field can be resolved using an operation of multiple values of fields within the inventory database.

Similar to advertisement group service module 330 in FIG. 3, the communication module 406 can be configured to provide an advertisement for a product to one or more search engines (e.g., servers and/or processes associated with the search engines) such that that advertisement can be displayed by the search engine(s) in response to one or more search requests at the search engine(s). For example, after two different advertisements are defined for the product 412 (i.e., football jersey) and the product 414 (i.e., basketball jersey), respectively, using the advertisement rule for jerseys at the advertisement definition module 404, the communication module 406 can be configured to send the advertisements to a search engine (not shown in FIG. 4) operatively coupled to a host device that hosts the processor 400. As a result, the advertisement for the product 412 or the product 414 can be displayed by the search engine in response to a search request at the search engine that queries a football jersey or a basketball jersey.

The inventory monitor module 408 can be configured to monitor the inventory database 410 based on one or more advertisement rules. The inventory monitor module 408 can, based on the one or more advertisement rules, provide an indication to the advertisement definition module 404 or any other portion of the processor 400 if a value of a field for a product stored in the inventory database 410 and associated with an advertisement rule is modified. In response to receiving such an indication, the advertisement definition module 404 can be configured to take actions on one or more advertisements defined for that product accordingly.

In some embodiments, based on the indication, the advertisement definition module 404 can be configured to define a new advertisement or update an existing advertisement for the product. In such embodiments, the advertisement definition module 404 can be configured to resolve a dynamic field of the advertisement, which is associated with the modified field, using the modified value for that field retrieved from the inventory database 410. For example, if the URL for the product 412 stored in the inventory database 410 is changed the URL is associated with an advertisement rule, the inventory monitor module 408 can be configured to detect the change and send an indication to the advertisement definition module 404 in response to the change. In response to receiving such an indication, the advertisement definition module 404 can be configured to resolve the dynamic field “website address” of the advertisement for the product 412 using the modified URL retrieved from the inventory database 410. As a result, the new URL is displayed in the updated advertisement for the product 412.

In some other embodiments, based on the indication, the advertisement definition module 404 can be configured to send a suspension indicator associated with one or more advertisements for the product to the communication module 406. Alternatively, the inventory monitor module 408 can be configured to generate and send the suspension indicator directly to the communication module 406. In response to receiving such a suspension indicator, the communication module 406 can be configured to send a request to one or more search engines to suspend displaying the advertisements for that product. For example, if the quantity for the product 412 stored in the inventory database 410 is decreased to 0, the inventory monitor module 408 can be configured to detect the change and then send an indication to the advertisement definition module 404, which is then configured to send a suspension indicator associated with an advertisement for the product 412 to the communication module 406. In response to receiving the suspension indicator, the communication module 406 can be configured to send a request to a search engine to suspend displaying the advertisement for the product 412. As a result, the advertisement for the product 412 is not displayed in response to any search request made at the search engine.

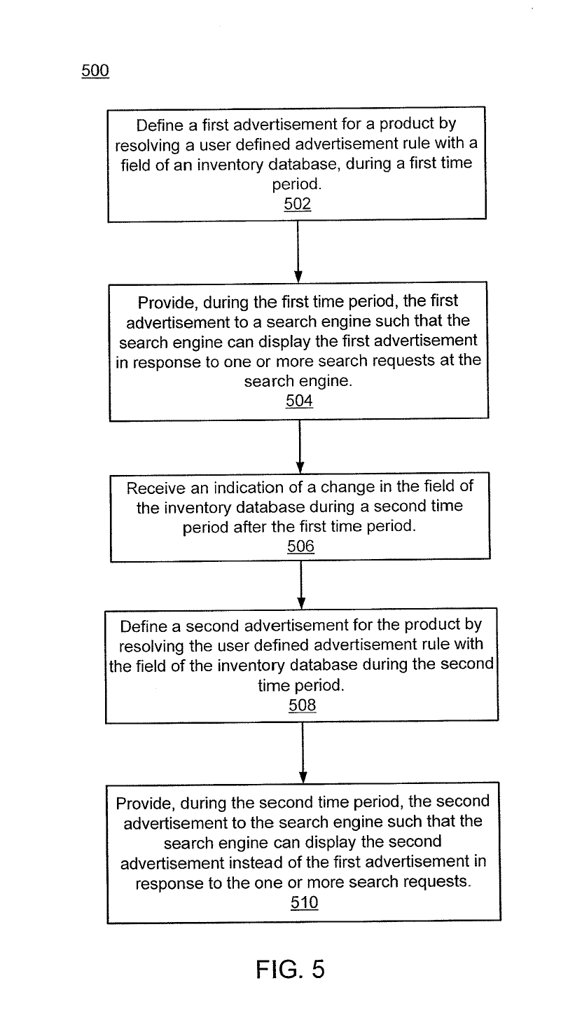

FIG. 5 is a flowchart illustrating a method for providing multiple advertisements for a product to a search engine (e.g., a server and/or process associated with a search engine), according to an embodiment. At 502, a first advertisement for a product can be defined during a first time period by resolving a user defined advertisement rule with a field of an inventory database. The user defined advertisement rule associated with the product can be received and stored at a dynamic rule module (e.g., dynamic rule module 402 in FIG. 4). The user defined advertisement rule can include a dynamic field associated with a field in the inventory data for the product that is stored in the inventory database. Subsequently, an advertisement definition module (e.g., advertisement definition module 404 in FIG. 4) can be configured to define the first advertisement for the product based on the user defined advertisement rule, during the first time period. Specifically, the advertisement definition module can be configured to resolve the dynamic field with a datum retrieved from the associated field within the inventory database. As a result, the first advertisement can be defined at the advertisement definition module.

In the example described with respect to FIG. 4, for example, an advertisement rule for jerseys can be defined by a retailer (not shown in FIG. 4) of the product 412, which is a model of football jersey. The advertisement rule has a dynamic field “price”, which is associated with price of the football jersey to be advertised. The advertisement rule can be uploaded by the retailer and received at the dynamic rule module 402. Subsequently, the advertisement definition module 404 can be configured to define a first advertisement for the football jersey based on the advertisement rule for jerseys, during a first time period. Specifically, the advertisement definition module 404 can be configured to resolve the dynamic field “price” using the values of the fields “retail price,” “shipping cost,” “additional costs,” and “profit” for the football jersey stored within the inventory database 410. As a result, the first advertisement for the football jersey can be defined at the advertisement definition module 404.

At 504, the first advertisement can be provided to a search engine, during the first time period, such that the search engine can display the first advertisement in response to one or more search requests at the search engine. Specifically, after the first advertisement is defined at the advertisement- definition module, a communication module (e.g., communication module 406 in FIG. 4) can be configured to send the first advertisement to a designated search engine, during the first time period. As a result, the first advertisement can be displayed at the search engine in response to search quests related to the product that are made at the search engine.

In the example described with respect to FIG. 4, after the first advertisement for the football jersey is defined at the advertisement definition module 404, the communication module 406 can be configured to send the first advertisement to a search engine (not shown in FIG. 4) operatively coupled to a host device that hosts the processor 400. The transmission can be done during the first time period (e.g., in the first day). As a result, the first advertisement for the football jersey can be displayed at the search engine in response to search quests related to football and/or jersey that are made at the search engine.

At 506, an indication of a change in the field of the inventory database can be received during a second time period after the first time period. Specifically, during the second time period, the change in the field of the inventory data for the product can be detected by an inventory monitor module (e.g., inventory monitor module 408 in FIG. 4). As a result, the inventory monitor module can be configured to generate and send an indication of the change to a corresponding component, such as the advertisement definition module, or the communication module.

In the example described with respect to FIG. 4, the “retail price” field for the football jersey can be changed by the retailer during a second time period after the first time period (e.g., the day after the first day). For example, the retailer can update the retail price for the football jersey stored in the inventory database 410 with a new value at the beginning of the day after the first day. Subsequently, the change in the “retail price” field for the football jersey can be detected by the inventory monitor module 408. As a result, the inventory monitor module 408 can be configured to generate and send an indication of the change to the advertisement definition module 404.

At 508, a second advertisement for the product can be defined during the second time period by resolving the user defined advertisement rule with the field of the inventory database. Similar to defining the first advertisement for the product, in response to receiving the indication from the inventory monitor module, the advertisement definition module can be configured to resolve the dynamic field with the updated value retrieved from the associated field within the inventory database. As a result, the second advertisement, which includes the updated value in the dynamic field, can be defined at the advertisement definition module during the second time period.

In the example described with respect to FIG. 4, in response to receiving the indication from the inventory monitor module 408, the advertisement definition module 404 can be configured to update the dynamic field “price” with the modified value retrieved from the associated field “retail price” for the football jersey stored within the inventory database 410. As a result, a second advertisement, which includes the updated “price”, can be defined at the advertisement definition module 404 during second time period.

At 510, the second advertisement can be provided to the search engine, during the second time period, such that the search engine can display the second advertisement instead of the first advertisement in response to the one or more search requests. Specifically, after the second advertisement is defined at the advertisement definition module, the communication module can be configured to send the second advertisement to the designated search engine, during the second time period. In response to receiving the second advertisement, the search engine can be configured to replace the first advertisement with the second advertisement. As a result, the second advertisement, instead of the first advertisement, can be displayed at the search engine in response to search queries related to the product received at the search engine.

In the example described with respect to FIG. 4, after the second advertisement for the football jersey is defined at the advertisement definition module 404, the communication module 406 can be configured to send the second advertisement to the search engine. The transmission can be done during the second time period. In response to receiving the second advertisement, the search engine can be configured to replace the first advertisement with the second advertisement. As a result, the second advertisement for the football jersey with the updated sale price, instead of the first advertisement, can be displayed at the search engine in response to search queries related to football and/or jersey received at the search engine.

While shown and described above with respect to FIGS. 1-4 as advertisement data being processed by a single processor in a single host device, in other embodiments, such processing can be done by more than one processor located in more than one host device. For example, the batched advertisement XML files can be distributed to and processed in parallel at a network of worker services located at multiple host devices. In such an example, the multiple host devices within the network can be operatively coupled to each other and coordinated to execute one or more common functions.

While shown and described above with respect to FIGS. 2-4 as functions associated with defining or delivering advertisements being automatically executed by one or more modules, in other embodiments, some of the functions can be manually executed by a user. For example, after a field of the inventory data for a product is updated, a user can manually send a command to a module in a host device to trigger the process for defining a new advertisement for that product. For another example, after an advertisement is defined in a host device, a user can manually deliver and/or send the advertisement to a designated search engine.

In some embodiments, one or more advertisements (e.g., advertisement 182 and/or 184 of FIG. 1) can be sent to one or more search engines (e.g., search engine 152 and/or 162 of FIG. 1). More specifically, in such embodiments and as used herein, sending an advertisement to a search engine means sending the advertisement to a device (e.g., search device 150 or 160 of FIG. 1) that hosts and/or executes a search engine process, processes advertisements associated with the search engine and/or stores advertisements associated with the search engine. For example, advertisements associated with the search engine can be stored at a memory within the search device (e.g., search device 150, 160 of FIG. 1) accessible to the search engine process. Thus, in response to receiving a search request associated with the advertisement, the search engine process can be configured to retrieve the advertisement from the memory of the device, and further process and/or display the advertisement.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages (e.g., object-oriented programming languages) and development tools. Additional examples of computer code include, but are not limited to, control signals, encrypted code, and compressed code.

While various embodiments have been described above, it should be understood that they have been presented by way of example only, not limitation, and various changes in form and details may be made. Any portion of the apparatus and/or methods described herein may be combined in any combination, except mutually exclusive combinations. The embodiments described herein can include various combinations and/or sub-combinations of the functions, components and/or features of the different embodiments described.

What is claimed is:

1. A non-transitory processor-readable medium storing code representing instructions to be executed by a processor, the code comprising code to cause the processor to:
receive a user defined advertisement rule associated with a plurality of products listed within an inventory database, the user defined advertisement rule having at least one dynamic field associated with a field within the inventory database including a product title field, a brand name field, a website address field, a description field, a past price field, a retail cost field or a shipping price field;
resolve the at least one dynamic field for each product from the plurality of products using a datum stored within the field within the inventory database to define a different advertisement for each product from the plurality of products; and
provide the different advertisement for each product from the plurality of products to a search engine such that each advertisement can be displayed by the search engine in response to one or more search requests at the search engine.

2. The non-transitory processor-readable medium of claim 1, wherein the at least one dynamic field is associated with the product title field, the code to cause the processor to resolve includes code to cause the processor to resolve the at least one dynamic field such that:
a product title within the advertisement for a product from the plurality of products has a first format if the product title in the first format has a number of characters less than a character limit, and
the product title within the advertisement for the product has a second format if the product title in the first format has a number of characters greater than or equal to the character limit.

3. The non-transitory processor-readable medium of claim 1, wherein the at least one dynamic field is associated with the website address field, the code to cause the processor to resolve includes code to cause the processor to resolve the at least one dynamic field such that:
a website address associated with a product from the plurality of products is included in the advertisement for that product if the website address associated with the product has a number of characters less than a character limit, and
a default website is included in the advertisement for the product if the website address associated with the product has a number of characters greater than or equal to the character limit.

4. The non-transitory processor-readable medium of claim 1, wherein the code to cause the processor to resolve includes code to cause the processor to resolve the at least one dynamic field such that a value within the advertisement for a product from the plurality of products is converted from a format stored in the field within the inventory database to a common display format.

5. The non-transitory processor-readable medium of claim 1, the code further comprising code to cause the processor to:
receive an indication of a change in a value of the field of the inventory database; and
send, based on the indication, a request to the search engine to suspend displaying the advertisement for a product from the plurality of products.

6. The non-transitory processor-readable medium of claim 1, the code further comprising code to cause the processor to:
receive an indication of a change in a value of the field of the inventory database;
resolve, based on the indication, the at least one dynamic field for at least one product from the plurality of products to define an updated advertisement for the at least one product; and
provide the updated advertisement to the search engine such that the updated advertisement can be displayed by the search engine in response to the one or more search requests.

7. The non-transitory processor-readable medium of claim 1, wherein the search engine is a first search engine, the code further comprising code to cause the processor to:
provide the different advertisement for each product from the plurality of products to a second search engine such that each advertisement can be displayed by the second search engine in response to one or more search requests at the second search engine.

8. The non-transitory processor-readable medium of claim 1, wherein the at least one dynamic field is associated with the shipping price field, the code to cause the processor to resolve includes code to cause the processor to resolve the at least one dynamic field such that the advertisement for a product from the plurality of products includes shipping information associated with that product.

9. The non-transitory processor-readable medium of claim 1, wherein the at least one dynamic field is a first dynamic field and the field within the inventory database is a first field within the inventory database, the user defined advertisement rule having a second dynamic field associated with a second field within the inventory database
the code comprising code to cause the processor to resolve includes code to cause the processor to resolve the first dynamic field and the second dynamic field with a calculation using the datum stored within the first field and a datum stored within the second field as inputs.

10. A non-transitory processor-readable medium storing code representing instructions to be executed by a processor, the code comprising code to cause the processor to:
define, during a first time period, a first advertisement for a product by resolving a user defined advertisement rule with a field of an inventory database;
provide, during the first time period, the first advertisement to a search engine such that the search engine can display the first advertisement in response to one or more search requests at the search engine;
receive, during a second time period after the first time period, an indication of a change in the field of the inventory database;
define, during the second time period, a second advertisement for the product by resolving the user defined advertisement rule with the field of the inventory database; and
provide, during the second time period, the second advertisement to the search engine such that the search engine can display the second advertisement instead of the first advertisement in response to the one or more search requests.

11. The non-transitory processor-readable medium of claim 10, wherein the field of the inventory database is one of a product title field, a brand name field, a quantity field, a website address field, a description field, a past price field, a retail cost field, or a shipping price field.

12. The non-transitory processor-readable medium of claim 10, wherein the search engine is a first search engine, the code further comprising code to cause the processor to:
provide, during the second time period, the second advertisement to a second search engine such that the second search engine can display the second advertisement in response to one or more search requests at the second search engine.

13. The non-transitory processor-readable medium of claim 10, wherein the product is a first product, the code further comprising code to cause the processor to:
define, during the first time period, an advertisement for a second product by resolving the user defined advertisement rule with the field of the inventory database; and
provide, during the first time period, the advertisement for the second product to the search engine such that the search engine can display the advertisement for the second product in response to one or more search requests at the search engine.

14. The non-transitory processor-readable medium of claim 10, wherein the field of the inventory database is a product title field, the code to cause the processor to define the first advertisement includes code to cause the processor to resolve the user defined advertisement rule such that:
a product title within the advertisement for the product has a first format if the product title in the first format has a number of characters less than a character limit, and
the product title within the advertisement for the product has a second format if the product title in the first format has a number of characters greater than or equal to the character limit.

15. The non-transitory processor-readable medium of claim 10, wherein the field of the inventory database is a website address field, the code to cause the processor to define the first advertisement includes code to cause the processor to resolve the user defined advertisement rule such that:
a website address associated with the product is included in the first advertisement for the product if the website address associated with the product has a number of characters less than a character limit, and
a default website is included in the first advertisement for the product if the website address associated with the product has a number of characters greater than or equal to the character limit.

16. The non-transitory processor-readable medium of claim 10, wherein the change is a first change, the code further comprising code to cause the processor to:
receive, during a third time period after the second time period, an indication of a second change in the field of the inventory database; and
send, in response to the indication of the second change and during the third time period, a suspension indicator instructing the search engine to suspend displaying the second advertisement.

17. The non-transitory processor-readable medium of claim 10, wherein the field of the inventory database is a first field of the inventory database,
the code comprising code to cause the processor to define the first advertisement includes code to cause the processor to define the first advertisement for the product by resolving the user defined advertisement rule based on a calculation using a value of the first field of the inventory database and a value of a second field of the inventory database as inputs.

18. An apparatus, comprising:
a dynamic rule module configured to receive a user defined advertisement rule having at least one dynamic field, the dynamic rule module configured to associate the user defined advertisement rule with a plurality of products stored within an inventory database, the dynamic rule module configured to associate the at least one dynamic field with a field within the inventory database, each product from the plurality of products having a value associated with the field within the inventory database;
an advertisement definition module configured to resolve the at least one dynamic field for each product from the plurality of products using the value associated with the field for that product to define a different advertisement for each product from the plurality of products; and
a communication module configured to provide the different advertisement for each product from the plurality of products to a search engine such that each advertisement can be displayed by the search engine in response to one or more search requests at the search engine.

19. The apparatus of claim 18, wherein the field within the inventory database is one of a product title field, a brand name field, a quantity field, a website address field, a description field, a past price field, a retail cost field, or a shipping price field.

20. The apparatus of claim 18, further comprising:
an inventory monitor module configured to monitor the inventory database, the inventory monitor module configured to provide an indication to the advertisement definition module if the value for a product from the plurality of products is modified,
the advertisement definition module configured to resolve, based on the indication, the at least one dynamic field for that product using the value for that product.

21. The apparatus of claim 18, further comprising:
an inventory monitor module configured to monitor the inventory database, the inventory monitor module configured to provide an indication to the advertisement definition module if the value for a product from the plurality of products is modified,
the advertisement definition module configured to send, based on the indication, a suspension indicator to the communication module such that the communication module can send, based on the suspension indicator, a request to the search engine to suspend displaying the advertisement for the product from the plurality of products.

22. The apparatus of claim 18, wherein the search engine is a first search engine, the communication module configured to provide the different advertisement for each product from the plurality of products to a second search engine such that each advertisement can be displayed by the second search engine in response to one or more search requests at the second search engine.

23. The apparatus of claim 18, wherein the at least one dynamic field is a first dynamic field and the field within the inventory database is a first field within the inventory database, the user defined advertisement rule having a second dynamic field,
the dynamic rule module configured to associate the second dynamic field with a second field within the inventory database, each product from the plurality of products having a value associated with the second field within the inventory database,
the advertisement definition module configured to resolve the first dynamic field and the second dynamic field for each product from the plurality of products based on a calculation using the value associated with the first field of the inventory database and a value associated with the second field of the inventory database as inputs.
